(19) United States
(12) Patent Application Publication
(10) Pub. No.: US 2009/0278864 A1
(43) Pub. Date: Nov. 12, 2009

(54) DISPLAY METHOD OF LIQUID CRYSTAL DISPLAY DEVICE

(75) Inventor: Meng-Chao Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/336,552

(22) Filed: Dec. 17, 2008

(30) Foreign Application Priority Data
May 8, 2008 (TW) 97116987

(51) Int. Cl. G09G 5/10

(52) U.S. Cl. 345/690

(57) ABSTRACT

A display method of a liquid crystal display device is provided. First, a liquid crystal display device is provided. Then, the relationship between a gray level and brightness of various view angles is detected. After that, a relationship table of input gray level and output gray level of the corresponding view angles is obtained according to the relationship between gray level and brightness of the view angles. Thereafter, an angle value is inputted to the liquid crystal display device. Then, the liquid crystal display device outputs a gray level corresponding to the angle value through the relationship table of input gray level and output gray level.

### CROSS-REFERENCE TO RELATED APPLICATION

This application claims the priority benefit of Taiwan application serial no. 97116987, filed on May 8, 2008. The entirety of the above-mentioned patent application is hereby incorporated by reference herein and made a part of this specification.

### BACKGROUND OF THE INVENTION

1. Field of the Invention

The present invention relates to a method of improving the display performance of a display device, and in particular, to a display method of a liquid crystal display device with better display performance.

2. Description of Related Art

A liquid crystal display (LCD) becomes the mainstream of the display devices in the market in the recent years. Part of the reason is due to environmental consideration. Moreover, the LCD is characterized in high resolution, good space usage, low operating voltage, and without radiation. In addition, the LCD has advantages such as high contrast ratio, no gray level inversion, little color shift, high brightness, high color saturation, high responsive speed, and a wide-viewing angle.

In order to meet the requirement of the wide-viewing angles, the current techniques utilize a twisted nematic (TN) LCD panel along with a wide-viewing film, an in-plane switching (IPS) LCD panel, a fringe field switching LCD panel, and a multi-domain vertical alignment (MVA) LCD panel. Therefore, to meet the requirement of the wide-viewing angles, it is required to use particular liquid crystal materials or to make particular designs on the LCD panels. Thereby, the process complexity and the process cost are increased. Besides, when viewing the LCD panel of the wide-viewing angle at a larger view angle, a color shift problem of middle gray levels also occurs.

### SUMMARY OF THE INVENTION

The present invention relates to a display method of a liquid crystal display (LCD) device, which has better display performance.

In order to specifically describe the invention, a display method of an LCD device is provided herein. First of all, an LCD device is provided. Next, relationships between gray level and brightness of various view angles of the LCD device is detected. Then, a relationship table of input gray level and output gray level of the corresponding view angles is obtained according to the relationships between the gray level and the brightness of the view angles. After that, an angle value is inputted to the LCD device. Thereafter, a gray level to be outputted corresponding to the angle value is outputted from the LCD device through the relationship table of input gray level and output gray level.

According to one embodiment of the present invention, if the angle value is between the view angles, the gray level to be outputted corresponding to the angle value is obtained by using an interpolation method.

According to one embodiment of the present invention, when the gray level to be outputted corresponding to the angle value is not an integral, a dither method or a frame rate control (FRC) method is performed, and then the gray level to be outputted is outputted.

According to one embodiment of the present invention, a method of inputting the angle value to the LCD device is directly inputting the angle value to the LCD device.

According to one embodiment of the present invention, the LCD device further comprises a signal receiver.

According to one embodiment of the present invention, a method of inputting the angle value to the LCD device is using a movable apparatus to output a signal having the angle value to the signal receiver of the LCD device.

According to one embodiment of the present invention, the signal receiver has a function of automatically detecting a movable apparatus, and a method of inputting the angle value to the LCD device is using the signal receiver to automatically detect the angle value of a position of the movable apparatus.

According to one embodiment of the present application, the movable apparatus includes a remote control.

In the present invention, by utilizing the relationship table of input gray level and output gray level of various view angles, and by inputting an angle value to the LCD device, the LCD device can adjust the outputted gray level according to the relationship table of input gray level and output gray level of various view angles, and thereby, the LCD device can provide the optimal performance at the angle value.

In order to make the above and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a display method of a liquid crystal display (LCD) device according to the present invention.

FIG. 2 is a top view illustrating an LCD device of the present invention.

FIG. 3 is a relationship diagram of a gray level and brightness from 9 view angles of the LCD device of the present invention.

FIG. 4 is a relationship table of input gray level and output gray level of the 9 view angles of the LCD device.

### DESCRIPTION OF EMBODIMENTS

The present invention is directed to improving the display performance when a liquid crystal display (LCD) device is at a larger view angle. A method to achieve the above-mentioned goal is detecting a relationship between gray level and brightness of various view angles, and obtaining a relationship between input gray level and output gray level of each of the view angles according to the relationship between gray level and brightness of each of the view angles. Then, a relationship table of input gray level and output gray level of these view angles is established. Thereby, a user can input a signal having an angle value of a position of the user, and the LCD device gets the relationship between input gray level and output gray level at the angle value of the position of the user by looking up table, for example. Thereby, the LCD device can adjust the gray level outputted from the LCD device to provide the optimal display performance at the angle value of the position of the user. Embodiments of the present invention are described in detail hereinafter.

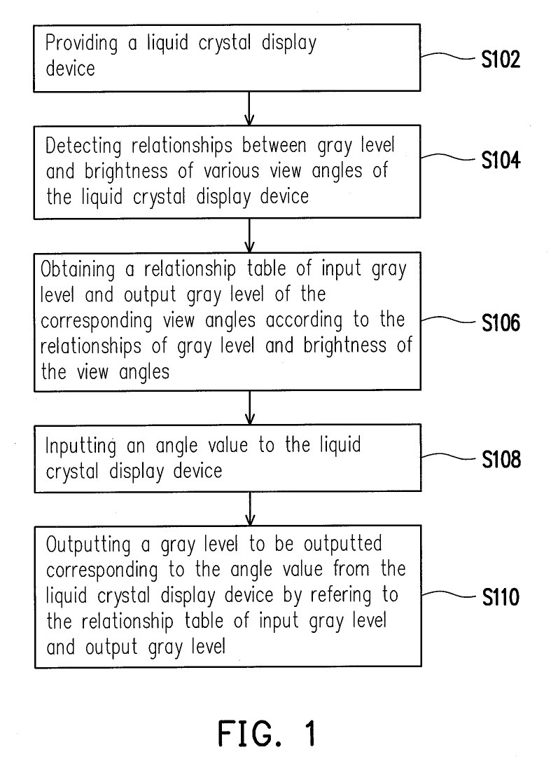

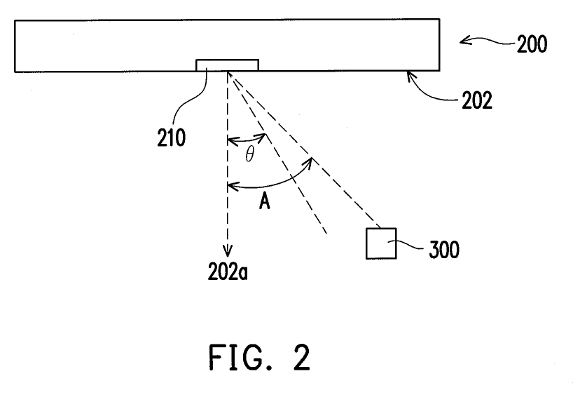

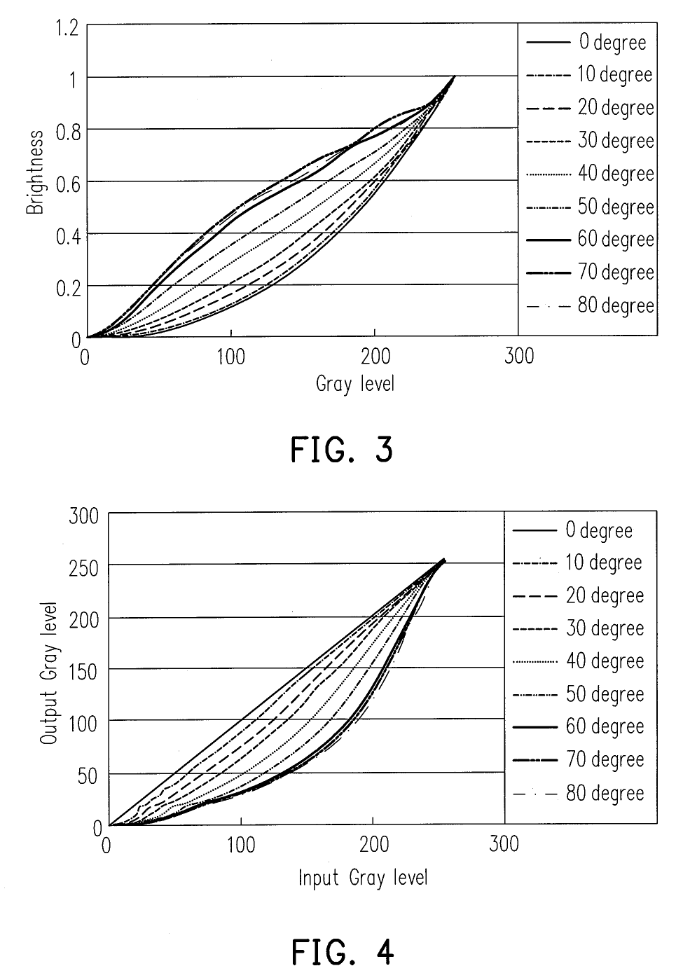

FIG. 1 is a flowchart illustrating a display method of an LCD device according to the present invention. FIG. 2 is a top view illustrating the LCD device of the present invention. Please refer to FIGS. 1 and 2. First, in a step S102, an LCD device 200 is provided. The LCD device 200 has a display plane 202. According to the present embodiment, a view angle θ refers to an angle between, for example, a user and a vertical axis 202a of the display plane 202. The view angle θ is less than 90 degrees. Next, relationships between gray level and brightness of various view angles θ of the LCD device 200 is detected in a step S104. According to the present embodiment, as shown in FIG. 3, the relationships between gray level and brightness of 9 view angles (e.g. 0 degree, 10 degrees, 20 degrees, 30 degrees, 40 degrees, 50 degrees, 60 degrees, 70 degrees, and 80 degrees) is detected. However, the present invention is not limited to the above-mentioned. In other embodiments, the relationships between gray level and brightness of various view angles (e.g., more than 9 view angles) can be detected.

Normally, when watching the LCD device 200 in a position at a view angle of 0 degree, the contrast, the brightness of the image, and so forth are in the best condition. However, as the view angle is getting larger, the display performance or the display quality is compromised. Therefore, in the present invention, after detecting relationships between gray level and brightness of various view angles θ of the LCD device 200, by using the result of the detection, gamma curves of the view angles of 10 degrees, 20 degrees, 30 degrees, 50 degrees, 60 degrees, 70 degrees and 80 degrees are adjusted to conform with the standard of the view angle of 0 degree. Therefore, the next step (step S106) is obtaining a relationship table (as shown by FIG. 4) of input gray level and output gray level of each of the view angles θ according to the relationship between gray level and brightness of each of the view angles (as shown by FIG. 3).

Thereby, when watching the LCD device, the relationship between input gray level and output gray level from the 9 view angles θ can be obtained according to the view angle through a look-up-table method (i.e., looking up a relationship table of input gray level and output gray level). The detailed descriptions are as follows.

In a step S108, an angle value A is inputted to the LCD device 200. The angle value A is, for example, an angle included by the vertical axis 202a and a position of a user (not shown) with respect to the display plane 202, and the angle value A is less than 90 degrees. Then, in a step S110, a gray level to be outputted corresponding to the angle value A is outputted from the LCD device 200 by referring to the relationship table (as shown by FIG. 4) of input gray level and output gray level. In the step S108, a method of inputting the angle value A may include directly inputting the angle value A of the position of the user to the LCD device 200, or automatically detecting the angle value A of the position of the user to input the angle value A.

According to one embodiment of the present invention, the method of inputting the angle value A is directly inputting the angle value A of the position of the user to the LCD device 200, i.e., manually inputting the angle value A of the position of the user to the LCD device 200. Referring to FIG. 2, the LCD device 200 has a signal receiver 210, and a movable apparatus 300 (e.g. a remote control) is designed with a button or a rotary knob for inputting the angle value. A method of inputting the angle value A to the LCD device 200 is that the user outputs a signal having the angle value A to the signal receiver 210 of the LCD device 200 through the button or the rotary knob of the movable apparatus 300. When the signal receiver 210 of the LCD device 200 receives the angle value A inputted by the user, the LCD device 200 performs the look-up-table method (i.e., looking up the relationship table of input gray level and output gray level), and then outputs the gray level to be outputted corresponding to the angle value A, so that the user (the one who watches the LCD device 200) can watch the LCD device 200 with the optimal image output quality at the position of the user.

According to another embodiment, the method of inputting the angle value A is automatically detecting the angle value A of a position of a user to input it. Referring to FIG. 2, the signal receiver 210 has a function of automatically detecting a position of the movable apparatus 300 (e.g. the remote control). Therefore, the method of inputting the angle value A to the LCD device 200 is automatically detecting the angle value A of the movable apparatus 300 on the user's hand through the signal receiver 210. Similarly, when the signal receiver 210 of the LCD device 200 receives the angle value A of the movable apparatus 300 on the user's hand, the LCD device 200 performs the look-up-table method (i.e., looking up the relationship table of input gray level and output gray level), and then outputs the gray level to be outputted corresponding to the angle value A, so that the user (the one who watches the LCD device 200) can watch the LCD device 200 with the optimal image output quality at the position of the user.

Therefore, whether the angle value A is inputted by manually or by the automatic detecting method, the user can watch the LCD device 200 at any position in front of the display plane 202 because the LCD device 200 can make adjustments according to the position of the user to provide the optimal display performance. There is no such problem that the display picture tends to have a color shift of middle gray level, which may occurs when watching a traditional LCD panel of the wide view angle at a larger view angle.

Furthermore, it should be noted that, in the present embodiment, the relationship table of input gray level and output gray level only has the data of input gray level and output gray level in respect of 9 view angles, i.e., 0 degree, 10 degrees, 20 degrees, 30 degrees, 40 degrees, 50 degrees, 60 degrees, 70 degrees, and 80 degrees. If the angle value is between any two view angles of the 9 view angles (e.g. between 15 degrees and 35 degrees), the gray level to be outputted corresponding to the angle value is obtained by using an interpolation method.

Further, by looking up the relationship table of input gray level and output gray level, if it is found that the gray level to be outputted corresponding to the angle value is not an integral, a dither method or a frame rate control (FRC) method may be performed first, and then the gray level to be outputted is outputted.

In summary, the present invention utilizes the relationship table of input gray level and output gray level of various view angle, and the angle value of the position of the user inputted to the LCD device, so that the LCD device can adjust the outputted gray level through the look-up-table method, and thereby the LCD device can provide the optimal performance at the angle value of the position of the user. The present invention can be achieved by using the LCD device to perform simple calculations. The method is simple and does not increase the process cost. Furthermore, the present invention can apply to all kinds of LCD devices, and therefore, the applicability is great.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display method of liquid crystal display (LCD) device, comprising:
providing a liquid crystal display device;
detecting relationships between gray level and brightness of various view angles of the liquid crystal display device;
obtaining a relationship table of input gray level and output gray level of the corresponding view angles according to the relationships between gray level and brightness of the view angles;
inputting an angle value to the liquid crystal display device; and
outputting a gray level to be outputted corresponding to the angle value from the liquid crystal display device by referring to the relationship table of input gray level and output gray level.

2. The display method of the liquid crystal display device according to claim 1, wherein the gray level to be outputted corresponding to the angle value is obtained by using an interpolation method if the angle value is between the view angles.

3. The display method of the liquid crystal display device according to claim 2, wherein a dither method or a frame rate control (FRC) method is performed when the gray level to be outputted corresponding to the angle value is not an integral, and then the gray level to be outputted is outputted.

4. The display method of the liquid crystal display device according to claim 1, wherein a dither method or a frame rate control (FRC) method is performed when the gray level to be outputted corresponding to the angle value is not an integral, and then the gray level to be outputted is outputted.

5. The display method of the liquid crystal display device according to claim 1, wherein a method of inputting the angle value to the liquid crystal display device is directly inputting the angle value to the liquid crystal display device.

6. The display method of the liquid crystal display device according to claim 1, wherein the liquid crystal display device further comprises a signal receiver.

7. The display method of the liquid crystal display device according to claim 6, wherein a method of inputting the angle value to the liquid crystal display device is using a movable apparatus to output a signal having the angle value to the signal receiver of the liquid crystal display device.

8. The display method of the liquid crystal display device according to claim 7, wherein the movable apparatus includes a remote control.

9. The display method of the liquid crystal display device according to claim 6, wherein the signal receiver has a function of automatically detecting a movable apparatus, and a method of inputting the angle value to the liquid crystal display device is using the signal receiver to automatically detect the angle value of a position of the movable apparatus.

10. The display method of the liquid crystal display device according to claim 9, wherein the movable apparatus includes a remote control.
